(19) United States
(12) Patent Application Publication
(10) Pub. No.: US 2011/0211971 A1
(43) Pub. Date: Sep. 1, 2011

(54) ROTOR BLADE FOR A WIND POWER PLANT, WIND POWER PLANT AND METHOD FOR THE PRODUCTION OF A ROTOR BLADE

(75) Inventors: Urs Bendel, Fockbek (DE); Enno Eyb, Kiel (DE)

(73) Assignee: REPOWER SYSTEMS AG, Hamburg (DE)

(21) Appl. No.: 13/032,261

(22) Filed: Feb. 22, 2011

(30) Foreign Application Priority Data
Feb. 26, 2010 (DE) 10 2010 002 432.5

(51) Int. Cl. F03D 11/02

(52) U.S. Cl. 416/241 R

(57) ABSTRACT

A rotor blade (1) for a wind power plant that extends from a rotor blade root (2) substantially to a rotor blade tip (3), including a one-part or multi-part shell (10, 10′, 14) that is produced at least partially from a fiber reinforced composite material, and at least one belt (9-9′″) that is disposed in the rotor blade (1) substantially in the direction of a longitudinal extension of the rotor blade (1), wherein the at least one belt (9-9′″) has layers composed of a fiber reinforced composite material having fibers aligned unidirectionally in the direction of a longitudinal extension of the belt (9-9′″). Further, a wind power plant and a method for the production of a rotor blade (1) for a wind power plant is described.

### BACKGROUND OF THE INVENTION

The invention relates to a rotor blade for a wind power plant that extends from a rotor blade root substantially to a rotor blade tip, comprising a one-part or multi-part shell that is produced at least partially from a fiber reinforced composite material, and at least one belt that is disposed in the rotor blade substantially in the direction of a longitudinal extension of the rotor blade, where the at least one belt has layers composed of a fiber reinforced composite material having fibers aligned unidirectionally in the direction of a longitudinal extension of the belt. The invention further relates to a wind power plant and a method for the production of a rotor blade for a wind power plant.

Rotor blades for wind power plants are typically constructed from two shells, namely one shell for a suction side of the rotor blade and one shell for a pressure side of the rotor blade. The half shells are subsequently joined and bonded.

The shells for the rotor blades are typically based at least partially on fiber reinforced composite materials. For this purpose, in one possible design a plurality of layers of thin fiber fabrics is used. These can be initially placed dry into a mold and subsequently provided with a resin by means of a resin infusion process. Alternatively, so-called “pre-pregs” (from “pre-impregnated fibers”), that is, pre-impregnated fibers can be used. In this case, these are planar semi-finished products in which the fibers are already embedded in a layer of resin. After the assembly of the shell from pre-pregs, the shell is subjected to a negative pressure and heated so that the resin of the pre-preg layers joins into a firmly bonded resinous compound.

Typically, fabrics of differently oriented fibers are used for the shell. The fiber orientation in the layers which are used for assembling the shell is typically ±45°, that is partly +45° and partly −45°, to the longitudinal axis of the rotor blade. Such fiber fabrics are also designated as “2AX45” layers.

If degree values are discussed within the scope of the present invention, for instance 0° or 45°, then in the description of the prior art as well as in the description of the invention it should be implicit that manufacturing specific tolerances and deviations within a few degrees from an exact 0° layer or 45° layer happen and are comprised by the invention. Typical manufacturing tolerances are locally up to 2° to 5°.

The fiber reinforced composites have a high tensile strength in the direction of the fiber orientation due to the glass fibers, carbon fibers or synthetic fibers embedded therein. Therefore the use of “2AX45” layers for the shell of a rotor blade has the result that the shell has a comparatively low rigidity with respect to stresses in the flapwise direction. With this, the shell is resilient with respect to gusts of wind, with which the rotor blade is deflected out of the rotor blade plane. In the process, the rotor blade preferably bends in a direction perpendicular to a plane that is arranged between the leading edge and the trailing edge of the rotor blade airfoil. In an airfoil cross section of the rotor blade, this plane is also referred to as the “chord”.

In order to absorb these forces, the shells have belts which run in a longitudinal direction of the rotor blade. These belts ensure, in particular, flexural rigidity of the rotor blade, and in combination with webs, which are also disposed and fastened in the interior of the rotor blade, represent the support structure of the rotor blade. The belts which absorb and transmit these forces have fiber fabrics that have an orientation in the 0° direction, that is, parallel to the longitudinal axis of the rotor blade.

Belts in the rotor blade typically run as main belts on the inside of the shell on the suction side and on the pressure side of the rotor blade. Optionally, additional belts that also run in the longitudinal direction of the rotor blade, are frequently provided on the leading edge, and if applicable on the trailing edge of the rotor blade. These optional belts absorb bending forces on the rotor blade in the chord plane.

A main belt in the rotor blade of a wind power plant is typically constructed in either a resin infusion process or from prepreg layers, in order to achieve a longitudinal stiffness necessary for the rotor blade. The necessary longitudinal stiffness results from the loads acting on the rotor blade and, for example, the parameter of the tower clearance, i.e. the distance from the rotor blade tip to the outer wall of the tower. Depending on the size of the rotor blade, different numbers of layers are inserted. Thus, for example, up to 90 layers of fiber-glass reinforcements are used in a 50 m long rotor blade.

In the construction of the main belts of rotor blades, fiber-reinforced individual layers are usually used that have reinforcing fibers or a fabric made of corresponding fibers, which have a layer thickness of approx. 0.7 mm with a fiber layer weight of approx. 980 g/m² made of fiber-glass rovings. The hardened laminate made of this fabric has an elasticity modulus in the longitudinal direction of approx. 39,000 N/mm² with a fiber volume content of approx. 50%. The laminate is hereby preferably formed of epoxy resin. With a layer thickness of 0.7 mm, this yields a longitudinal stiffness of approx. 27,300 N/mm as a product of the elasticity modulus and the thickness of the individual layer.

Alternatively, the main belt can also have carbon fiber reinforced individual layers, for example, with a thickness of 0.45 mm per individual layer with a fiber areal weight of approx. 500 g/m² from carbon fiber rovings and an elasticity modulus in the longitudinal direction in the laminate of approx. 128,200 N/mm². A corresponding layer has a stiffness of approx. 57,690 N/mm. Thicker layers with thicknesses of up to 1.5 mm are also used occasionally.

The main belts, and if applicable, the belts on the leading edge and the trailing edge of a rotor blade, usually have a thickness of 3 cm to 8 cm and a width of 5 cm up to 1 m in the area of the blade root and into the rotor blade. Because the bending forces accumulated over the length of the rotor blade from the rotor blade tip to the rotor blade root are dissipated toward the rotor hub, the thickness of the belts is constant toward the rotor blade root. The thickness of the belt decreases gradually toward the rotor blade tip due to the space conditions that narrow gradually, and the lower accumulating bending forces.

The use of fiber reinforced individual layers for producing belts has the advantage of providing high strength and tensile strength of the support structure; however, belts particularly if they are produced from carbon fibers or carbon fiber rovings, are very expensive.

### BRIEF SUMMARY OF THE INVENTION

Therefore, the object of the present invention is to provide a rotor blade and a method for the production of the same, in which a rapid and cost-effective production is associated with a structural strength that is at least equal to, or exceeds, the structural strength of known rotor blades.

This object is solved by a rotor blade for a wind power plant that extends from a rotor blade root substantially to a rotor blade tip, comprising a one-part or multi-part shell that is produced at least partially from a fiber reinforced composite material, and at least one belt that is disposed in the rotor blade substantially in the direction of a longitudinal extension of the rotor blade, where the at least one belt layer composed of a fiber reinforced composite material has fibers aligned unidirectionally in the direction of the longitudinal extension of the belt, which is further characterized in that a thickness of the at least one belt decreases toward the blade root in a blade root side section whose length amounts to at least 3% of an entire length of the belt, wherein the shell has at least one layer of a fiber reinforced composite material having fibers aligned unidirectionally in the direction of the longitudinal extension of the rotor blade, wherein the layer in at least one section along the longitudinal extension of the rotor blade extends from an airfoil leading edge to an airfoil trailing edge of the rotor blade.

The invention is based on the fundamental idea that with the same or increased strength and tensile strength of the rotor blade, material and weight can be saved, and production time for the rotor blade can be shortened by tapering the at least one belt, at the end on the blade root side, already significantly before its end, that is, the thickness of the belt is reduced. The lower tensile strength of the belt at the end on the blade root side occurring, as a result, is absorbed by the introduction of a layer composed of a fiber reinforced composite, which also has fibers aligned in the 0° direction and which in a section along the longitudinal direction of the rotor blade extends over the entire extension of the rotor blade from the airfoil leading edge to the airfoil trailing edge.

Such a layer is also designated as a “full chord UD” layer, where “full chord” stands for the entire chord, that is, the line between the leading edge and the trailing edge of the rotor blade airfoil. And the abbreviation “UD” stands for “unidirectional”, that is, a layer having fibers aligned in one direction parallel to each other. This “full chord UD” layer imparts a higher stiffness to the shell in the longitudinal direction that suffices so that the belt can be tapered at the blade root side end. At the same time, the shell does not become significantly heavier. With a blade length of 40 m, the area in which the belt can be tapered to the blade root amounts to at least approx. 1.20 m or at least 3% of the belt length.

The “full chord” UD layer has the further technical effect that forces which are introduced from the belt into the shell material are distributed extensively over the shell. These stresses are no longer introduced strongly localized into the thin shell material, but rather distributed over a larger surface area. Therefore, the shell also can be dimensioned somewhat thinner than was previously possible, at least in the area of the belt.

Preferably, the length of the blade root side section of the at least one belt amounts to at least 10%, in particular at least 15%, in particular at least 20% of the entire length of the belt. With a rotor blade having a length of more than 50 m, this can mean a section length of more than 10 m, within which the thickness of the belt decreases towards the blade root. This implies a significant material and cost savings, particularly with the use of carbon fiber composites, in particular if the “full chord UD” layer is produced in contrast from a glass fiber composite.

Preferably, the at least one section along the longitudinal extension of the rotor blade, in which the layer of a fiber reinforced composite material, having fibers aligned unidirectionally in the direction of the longitudinal extension of the rotor blade, extends from an airfoil leading edge to an airfoil trailing edge of the rotor blade, amounts to at least 10%, in particular at least 30% of a length of the rotor blade. Here, preferably the area which is covered by the “full chord UD” layer overlaps the area in which the thickness of the belt decreases.

Further preferably, the at least one section along the longitudinal extension of the rotor blade in which a layer of a fiber reinforced composite material having fibers unidirectionally aligned in a direction of the longitudinal extension of the rotor blade, extends from an airfoil leading edge to an airfoil trailing edge of the rotor blade, occupies at least a range of 15% to 30%, in particular at least from 10% to 50%, in particular from 8% to 80% of a length of the rotor blade. This benefits the stability of the rotor blade.

The invention is advantageously further developed if the at least one belt has one or more casing layers, composed of a fiber reinforced composite having fibers aligned unidirectionally in the direction of the longitudinal extension of the belt, which substantially completely cover a top side and/or a bottom side of the belt. The casing layer encloses or covers the parts of the belt that are constructed of ramp-like stepped layers of fiber reinforced composite.

The decrease of the thickness of the belt towards the blade tip and towards the blade root is created in the ply design or layer design in that plys or layers of different lengths are applied at successive staggered positions along the longitudinal axis of the rotor blade. This has the consequence of steps in the lower and/or upper surface of the belt. In the case of strong stresses, these steps are vulnerable in that the lamination can loosen at the steps such that the layers fray and the integrity of the belt is jeopardized. A casing layer overlaps these steps and connects them in turn so they are firmly bonded to each other so that a tear or delamination of an individual layer at its ends is prevented.

An advantageous embodiment of the invention consists in that the shell or a shell part of the rotor blade has a core that has recesses, extending in the direction of the longitudinal extension of the rotor blade, in which the at least one belt is disposed. Such a core is typically composed of balsa wood or a foam material.

In the inventive further development, the inventive belt is embedded in the recesses of the core material, and thus sunk into the shell itself. In this case it is advantageous if the core and the at least one belt are connected to the at least one layer of fiber reinforced composite material having fibers aligned unidirectionally in the direction of the longitudinal extension of the rotor blade which extends at least in sections from the leading edge of the airfoil to the trailing edge of the airfoil of the rotor blade. This way, the core is directly covered by the inventive full chord UD layer. The stresses, which were absorbed by the belt, are therefore directly introduced into the full chord UD layer and distributed on this on the rotor blade. In this manner, point source loads of the shell material are avoided.

Particularly preferably, the core with the at least one belt disposed in its recess, is embedded on both sides in the one-part or multi-part shell. This embodiment results in a sandwich design in which on the outside and inside of the shell a fiber composite material having layers, for example, “2AX45” layers, is used between which the core is disposed with the belt embedded therein.

In addition to this, or alternatively to this, in an advantageous design of the invention, the at least one belt is disposed on an inside of the one-part or multi-part shell. In the scope of the present invention, the inside of the respective side of the shell is understood to represent the inside in the manufactured rotor blade, and it typically has a concave curvature. This manner of construction is simpler and faster to produce, at least if neither core nor belt are present in the interior of the shell, because the shell can already be completed before the belt is attached at the inside of the shell, in the finished state or layer by layer.

In this case also, it is advantageous if the at least one belt is connected to the at least one layer of fiber reinforced composite material having fibers, aligned unidirectionally in the direction of the longitudinal extension of the rotor blade, which extend at least in sections from the airfoil leading edge to the airfoil trailing edge of the rotor blade. Also in this case, point source loads that the belt exerts on the shell material, are introduced broadly in the shell material, and thus damaging point source loads are reduced or avoided in the shell.

The object underlying the invention is further solved by a wind power plant having an inventive rotor blade, as described above.

The object underlying the invention is also solved by a method for the production of a rotor blade for a wind power plant that extends from a rotor blade root substantially to a rotor blade tip, wherein a one-part or multi-part shell is produced at least partially from a fiber reinforced composite material and at least one belt, which is disposed in the rotor blade substantially in the direction of the longitudinal extension of the rotor blade, is produced from layers of a fiber reinforced composite material having fibers aligned unidirectionally in the direction of a longitudinal extension of the belt and is joined to the one-part or multi-part shell, that is developed further in that a thickness of the at least one belt is reduced toward the blade root in a blade root side section, whose length is at least 3% of the entire length of the belt, wherein the shell is provided with at least one layer of a fiber reinforced composite material having fibers aligned unidirectionally in the direction of the longitudinal extension of the rotor blade, wherein the layer in at least one section along the longitudinal extension of the rotor blade extends from an airfoil leading edge to an airfoil trailing edge of the rotor blade. Using this inventive method, the inventive rotor blade described above can be produced having the above named properties and advantages.

Within the scope of the present invention, the feature of joining the belt to the shell comprises the separate production of the belt and the shell, with the subsequent attachment or insertion of the belt in the shell, as well as the embedding of the belt in the not yet completely produced shell.

Further advantageous method steps lead to the designs of the inventive rotor blade described above. This relates particularly to the additional and/or alternative steps, of producing a shell having a core, creating a longitudinally extending recess in this core, and embedding a belt in this recess and joining it to the core.

In an additional advantageous further development of the inventive method, a belt is provided with a casing layer at its lower side and/or its upper side.

Preferably, a belt is fastened at an inside of the shell or of a shell part. Also preferably, the at least one “full chord UD” layer, that is, the at least one layer of fiber reinforced composite material having fibers aligned unidirectionally in the direction of the longitudinal extension of the rotor blade, which extends in at least one section along the longitudinal extension of the rotor blade from an airfoil leading edge to an airfoil trailing edge of the rotor blade, is connected to the belt.

All features and advantages, which are named with respect to one of the subject matters of the invention, apply in the same manner also to the other subject matters of the invention, that is, the inventive rotor blade, the inventive wind power plant and the inventive method for the production of the inventive rotor blade.

### BRIEF DESCRIPTION OF THE DRAWINGS

The invention is described below, without restricting the general idea of the invention, using exemplary embodiments with reference to the drawings, whereby we expressly refer to the drawings with regard to the disclosure of all details according to the invention that are not explained in greater detail in the text. The drawings show in:

FIG. 1 a schematic representation of a rotor blade,

FIG. 2 a schematic cross sectional representation through a part of an inventive rotor blade,

FIG. 3 a schematic cross sectional representation through a part of a further inventive rotor blade,

FIG. 4a) a schematic top view of an inventive rotor blade having an inventive belt,

FIG. 4b) a schematic representation of the layers of the belt according to FIG. 4a),

FIG. 4c) a schematic representation of a top view of the root side end of the belt according to FIGS. 4a) and 4b),

FIG. 5a) a schematic top view of a further inventive rotor blade having an inventive belt,

FIG. 5b) a schematic representation of the layers of the belt according to FIG. 5a),

FIG. 5c) a schematic representation of a top view of the root side end of the belt according to FIGS. 5a) and 5b),

FIG. 6a) a schematic top view of a further inventive rotor blade having an inventive belt,

FIG. 6b) a schematic cross sectional view of an airfoil of the rotor blade according to FIG. 6a), and

FIG. 6c) a schematic representation of the layers of the belt according to FIG. 6a).

### DETAILED DESCRIPTION OF THE INVENTION

In the following figures, the same or similar types of elements or corresponding parts are provided with the same reference numbers so that a corresponding re-introduction is omitted.

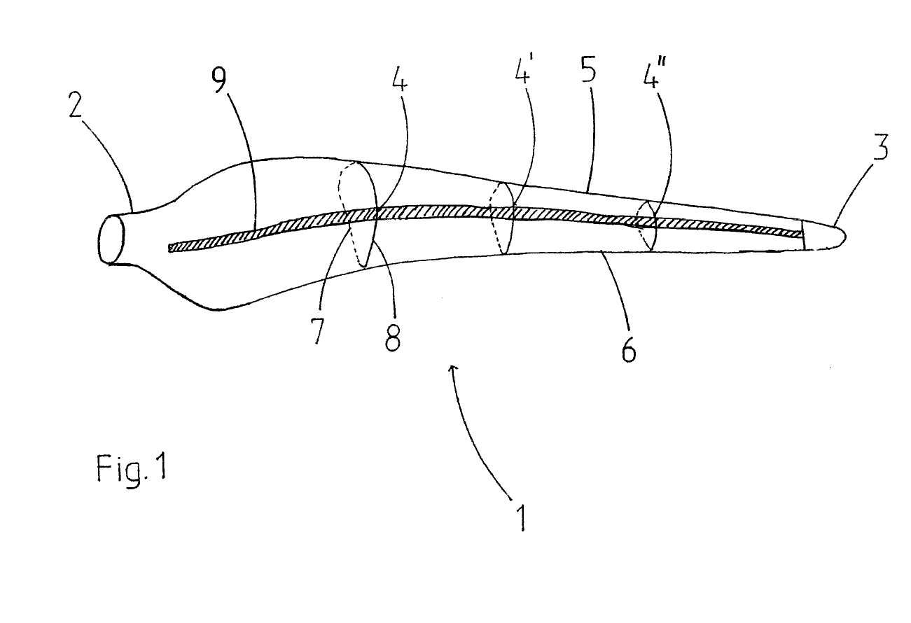

FIG. 1 schematically shows an inventive rotor blade 1 that has a longitudinal extension from a rotor blade root 2 to a rotor blade tip 3. Airfoil cross sections 4, 4′, 4″ are represented in the rotor blade 1 that are aerodynamically active and have a suction side 7 and a pressure side 8. The aerodynamic airfoil cross sections 4, 4′, 4″ further have an airfoil leading edge 5 and an airfoil trailing edge 6. The airfoil leading edge 5 is also designated as a “nose” of the airfoil.

FIG. 1 further shows a belt 9 which extends along the longitudinal extension of the rotor blade 1. The belt 9 ends before the tip 3 and before the rotor blade root 2 of the rotor blade 1. It can be seen in FIG. 1 that the belt adapts to the curve of the rotor blade 1 and is not completely straight. The deviations from the straight line are represented in FIG. 1 for visualization and are represented not to scale and enlarged. The belt 9 substantially follows the respective longitudinal extension of the rotor blade 1. An additional torsion about the longitudinal axis is not represented in the top view.

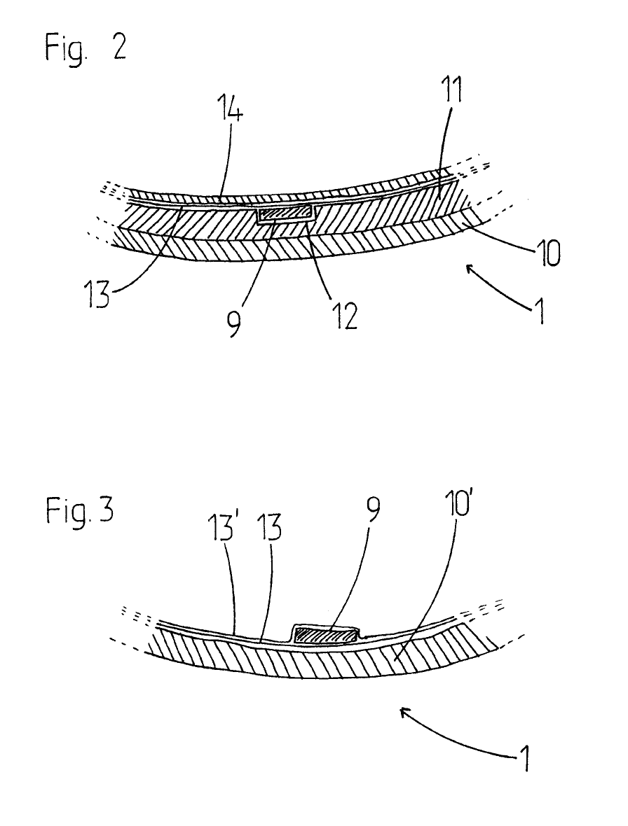

FIG. 2 shows in a schematic cross section, a section from an inventive rotor blade 1. This is a cross section through a shell or a half shell of a rotor blade 1 that is comprised of an outer shell part 10 composed of a fiber reinforced composite having “2AX45” layers, that is, fiber reinforced composite layers whose fibers are disposed in two main directions having +45° and −45° to the longitudinal axis of the rotor blade 1. A further ply or a further shell part 14 composed of a corresponding fiber reinforced composite having “2AX45” layers is present on the inside.

The shell parts 10 and 14 enclose a core 11 composed of balsa wood or a foam material that has a recess 12 which runs along the longitudinal direction of the rotor blade 1 extending into the plane of the sheet. The inventive belt 9 is inserted into the recess 12. The shapes of the belt 9 and the recess 12 are matched to each other.

In the production of the rotor blade 1 according to FIG. 2, the belt 9 is connected over a large area to the core 11 or to the side walls and to the bottom of the recess 12 of the core 11. In this exemplary embodiment, a layer 13 having fibers aligned unidirectionally in the direction of the longitudinal extension of the rotor blade 1, a so-called “full chord UD” layer, is located between the core 11 and the belt 9 on one side, and the shell part 14 on the other side. This is connected over a large area to the core 11, to the shell part 14, and to the belt 9. Because the fibers in the layer 13 are aligned parallel to the fibers in the belt 9, bending loads which are absorbed by the belt 9 are also introduced into the layer 13, and thus are distributed over a large area between the leading edge and the trailing edge of the airfoil. In this manner, fewer point source loads occur, and the structural integrity of the rotor blade 1 is improved.

FIG. 3 shows a schematic cross-section of an alternative embodiment. An outer shell part 10′, composed of a fiber composite material that is formed of layers of “2AX45” fabric, is connected toward the inside directly to a layer 13 having fibers aligned in the direction of the longitudinal axis of the rotor blade 1. On top of this layer, a belt 9 is disposed on one side, and is connected to the “full chord UD” layer 13. In this exemplary embodiment, a further “full chord UD” layer 13′, having fibers aligned in the longitudinal direction of the rotor blade 1, is provided that also encloses the first layer 13 as well as the belt 9.

Also with the variant shown in FIG. 3, the forces that are absorbed by the belt 9 are more uniformly distributed over the width of the shell or of the shell part 10′. In particular, shearing forces are thereby reduced between the different materials that otherwise could lead to a break or delamination of the belt from the shell material.

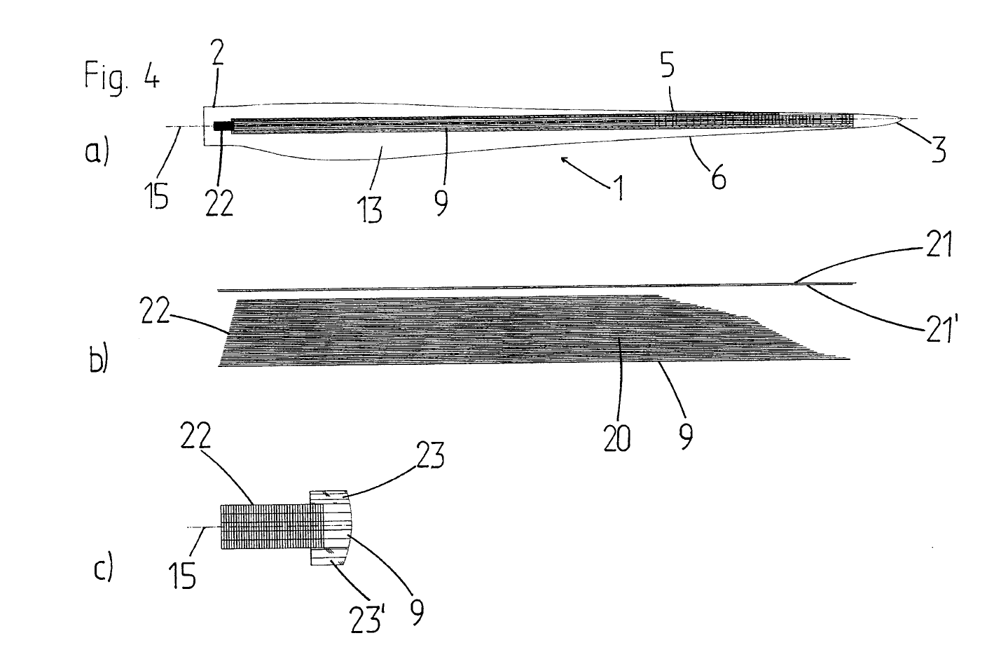

FIG. 4 schematically represents different aspects of the inventive rotor blade 1. The example represented in FIGS. 4a) and 4c) corresponds to a rotor blade having a length of approximately 40 m.

FIG. 4a) shows a schematic top view of an inventive rotor blade 1 whose longitudinal axis is marked with the reference numeral 15. A belt 9, which ends before the blade tip 3 and before the blade root 2, is disposed on the longitudinal axis 15 that runs through the blade root 2 and the blade tip 3. At the blade tip side end, the ends of the individual layers of the belt 9 that are stacked on top of each other are represented by horizontal lines. At the blade root side end, the thickness of the belt 9 also decreases, wherein however, this occurs with a shorter and tighter sequence of layer ends in a ramp 22 which therefore appears dark in FIG. 4a). The ramp 22 corresponds to a section that has a length of approximately 1.20 m in the longitudinal direction of the rotor blade 1.

The rotor blade 1 additionally has a “full chord UD” layer 13 that extends along the entire rotor blade 1 from the leading edge 5 to the trailing edge 6.

FIG. 4b) shows a schematic representation of a layer sequence of the layers 20 of the belt 9 from the rotor blade 1 according to FIG. 4a). The individual layers are each represented with respect to their length, that is, to the starting point and the endpoint along the length of the rotor blade 1; all curves, torsions, etc. are not represented. In other words, this is purely a placement plan.

FIG. 4b) clearly shows that at the root side end, the layers 20 are placed staggered above and behind one another, so that a ramp 22 results. At the blade tip side end, the thickness of the belt 9 decreases again by staggered layer ends, wherein however, the decrease of the thickness occurs over a larger longitudinal section. Additionally, two casing layers 21, 21′ are shown that, after construction of the belt with the two layers 20, are placed over the entire length of the belt 9, in order to cover the steps, which arise due to the layers being disposed in a staggered or stepped manner, and to prevent them from delaminating.

The illustration in FIG. 4b) is not true to scale. The length of the longest layer is approximately 37 m, while the thickness of the belt 9 in total is approximately 3 cm to 5 cm.

FIG. 4c) shows a detail section from FIG. 4a). A top view of the root side end of the belt 9 is shown schematically. The consecutive layer ends that are represented by lines, and that were fused into a dark block in FIG. 4a), can be seen clearly.

The length of the section, in which the ramp 22 is formed centered about the longitudinal axis 15, is approximately 1.2 m. The width of the belt 9 is approximately 50 cm. Sandwich transitions 23, 23′, having a width of 15 cm to 20 cm, are displaced toward the ends of the ramp 22, and are composed of balsa wood or a similar lightweight but stable material, and they form a transition from the belt 9 to the shell part lying underneath.

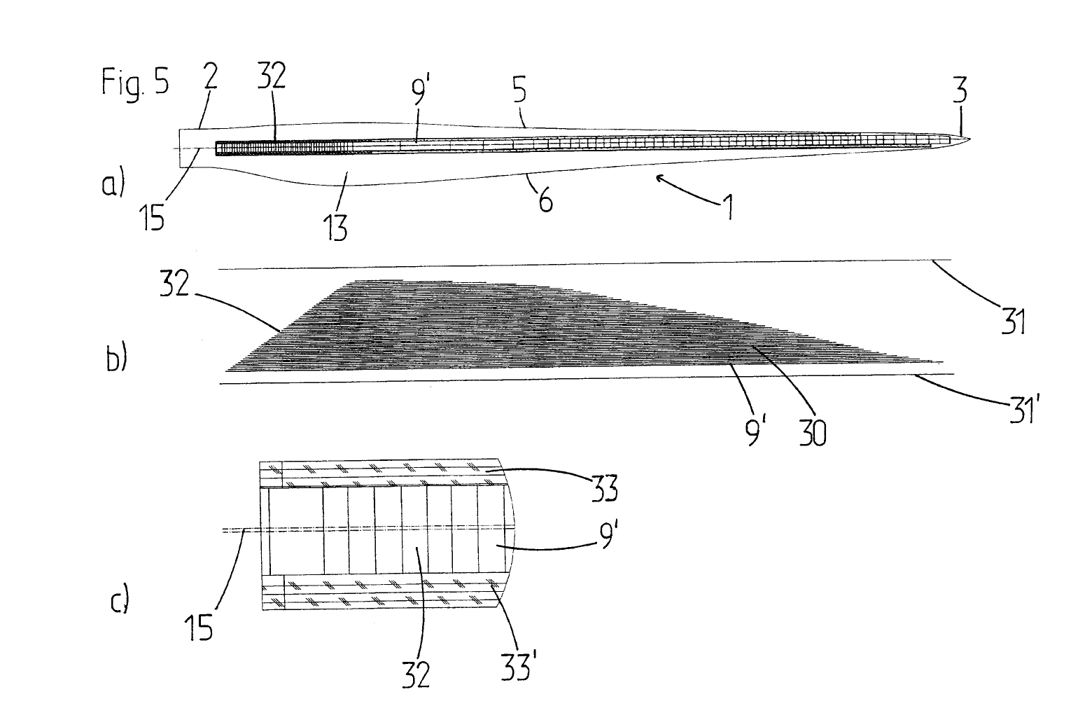

FIG. 5 shows a further example of the inventive rotor blade 1 having a belt 9′. The rotor blade has a length of approximately 46 m.

As seen in FIG. 5a), the belt 9′ has a ramp 32 in the area of the blade root 2 that extends over a larger area than in the exemplary embodiment according to FIG. 4a). Whereas in the exemplary embodiment according to FIG. 4a) approximately 40 layers were used for producing the belt 9, in the exemplary embodiment according to FIG. 5, approximately 54 layers are present.

The ramp 32 extends over an area of approximately 8 m. The reduction of the thickness of the belt 9′ towards the blade tip 3, which can be seen in FIG. 5a) by the horizontal lines, and is clearly recognizable in the side view in FIG. 5b), begins shortly after attaining the maximum thickness at approx. 11 m of the length of the rotor blade and extends over the remainder of the length of the belt 9′. The belt 9′ has a width of approx. 50 cm.

In FIG. 5b) the layers 30 of the belt 9′ are also shown. The belt 9′ has a casing layer 31, 31′ on both its top and its bottom that encases the top and the bottom and covers the entire length of the belt 9′.

It can be seen in FIG. 5c) that the longitudinal axis 15 is marked within a tolerance range of 5 mm. Sandwich transitions or balsa borders 33, 33′ connect adjacent to the belt 9′ in the direction of the shell.

As shown in FIG. 5a) and already seen in FIG. 4a), the sandwich edge and where applicable also the belt 9, come very close to the leading edge 5 and the trailing edge 6 of the rotor blade airfoil, in the direction of the blade tip 3. The belt 9, 9′ and the sandwich transitions 23, 23′, and 33, 33′ are reduced in their length or width at these locations.

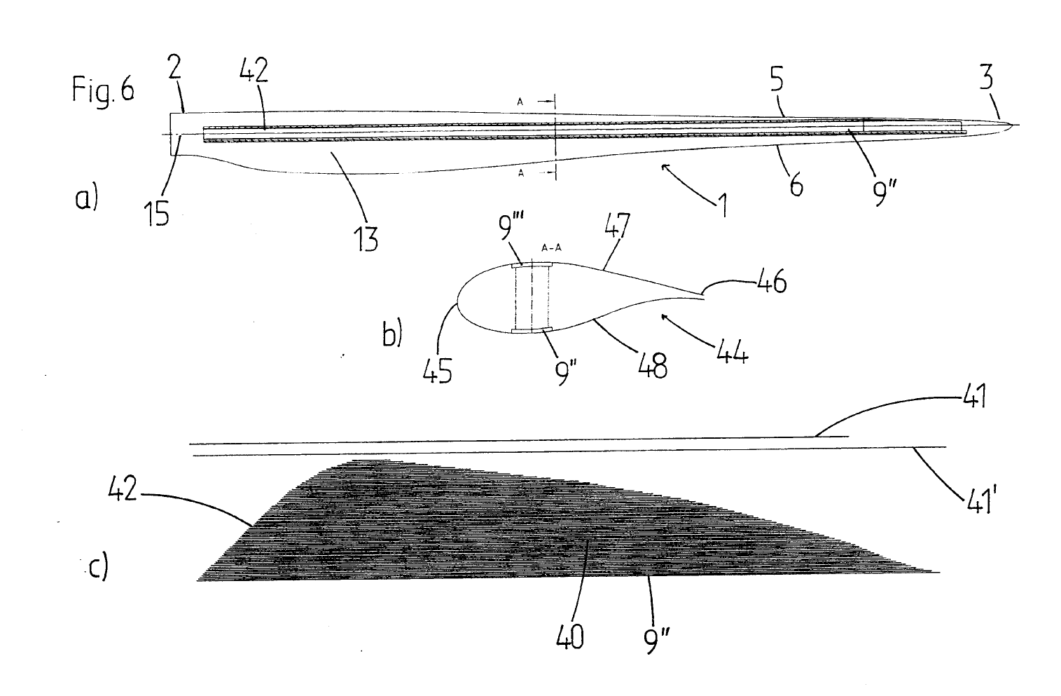

FIG. 6 shows a third exemplary embodiment of the inventive rotor blade 1, where in turn, FIG. 6a) shows a top view of the rotor blade 1 and FIG. 6c) shows a side view of a layer plan of a belt 9″ of the rotor blade 1 according to FIG. 6a). FIG. 6b) shows a cross-section of the rotor blade airfoil along a cross-sectional line A-A from FIG. 6a).

The rotor blade 1 represented in FIG. 6a) is a rotor blade having a length of approximately 50 m. The belt has a length of approximately 46 m with more than 70 layers of a unidirectional fiber reinforced composite. At its thickest location, the belt has a thickness of approximately 5 cm to 8 cm. The belt according to FIG. 6 has a width of approximately 60 cm and is, as shown in FIG. 6a), provided with a balsa border that on both sides has a width of 15 cm to 20 cm.

A ramp 42 that can be seen in FIG. 6c) has a sectional length of approximately 10 m, or more than 20% of the entire belt length. The belt 9″ is covered by two casing layers 41, 41′ that cover the stepped ends of the individual layers 40, and prevent delamination. The casing layers 41, 41′ are implemented with two layers at the most heavily loaded area.

FIG. 6b) shows an airfoil cross section 44 of the rotor blade 1 according to FIG. 6a) along a cutting line A-A. An airfoil cross section 44 having a thin shell is shown that extends between a leading edge 45 and a trailing edge 46 and has a suction side 47 and a pressure side 48. It is also shown that in each case a belt 9″ is disposed at both the suction side 47 and the pressure side 48, that in each case is already connected to the shell at the appropriate location.

According to the invention, the shell has a “full chord UD” layer 13 on both the suction side 47 and the pressure side 48 that extends at least in sections from the leading edge 45 to the trailing edge 46. One such “full chord UD” layer 13 is provided at the suction side 47 and/or the pressure side 48.

All named features, including those taken from the drawings alone, and individual features, which are disclosed in combination with other features, are considered individually and in combination as essential to the invention. Embodiments according to the invention can be fulfilled through individual characteristics or a combination of several characteristics.

### LIST OF REFERENCE SYMBOLS

1 Rotor blade
2 Rotor blade root
3 Rotor blade tip
4, 4′, 4″ Airfoil cross section
5 Airfoil leading edge
6 Airfoil trailing edge
7 Suction side
8 Pressure side
9-9′″ Belt
10, 10′ Shell part
11 Core
12 Recess
13, 13′ Unidirectional layer
14 Shell part
15 Longitudinal axis
20 Belt layers
21, 21′ Casing layers
22 Ramp
23, 23′ Sandwich transition
30 Belt layers
31, 31′ Casing layers
32 Ramp
40 Belt layers
41, 41′ Casing layers
42 Ramp
44 Airfoil cross section
45 Leading edge
46 Trailing edge
47 Suction side
48 Pressure side

1. A rotor blade (1) for a wind power plant that extends substantially from a rotor blade root (2) to a rotor blade tip (3), comprising:
a one-part or multi-part shell (10, 10′, 14) that is produced at least partially from a fiber reinforced composite material, and
at least one belt (9-9′″) that is disposed in the rotor blade (1) substantially in the direction of a longitudinal extension of the rotor blade (1),
wherein the at least one belt (9-9′″) has layers composed of a fiber reinforced composite material having fibers aligned unidirectionally in the longitudinal extension of the belt (9-9′″),
wherein the thickness of the at least one belt (9-9′″) decreases toward the blade root (2) in a blade root side section whose length is at least 3% of the entire length of the belt (9-9′″),
wherein the shell (10, 10′, 14) has at least one layer (13, 13′) of a fiber reinforced composite material having fibers aligned unidirectionally in the direction of the longitudinal extension of the rotor blade (1), and
wherein the layer (13, 13′) extends at least in one section along the longitudinal extension of the rotor blade (1) from an airfoil leading edge (5, 45) to an airfoil trailing edge (6, 46) of the rotor blade (1).

2. The rotor blade (1) according to claim 1, wherein the length of the blade root side section of the at least one belt (9-9′″) is at least 10% of the entire length of the belt (9-9′″).

3. The rotor blade (1) according to claim 1, wherein the at least one section along the longitudinal extension of the rotor blade (1) in which the layer (13, 13′) of a fiber reinforced composite material having fibers aligned unidirectionally in the direction of the longitudinal extension of the rotor blade (1), extends from an airfoil leading edge (5, 45) to an airfoil trailing edge (6, 46) of the rotor blade (1), amounts to at least 10% of a length of the rotor blade (1).

4. The rotor blade (1) according to claim 1, wherein the at least one section along the longitudinal extension of the rotor blade (1) in which the layer (13, 13′) of a fiber reinforced composite material having fibers aligned unidirectionally in the direction of the longitudinal extension of the rotor blade (1), extends from an airfoil leading edge (5, 45) to an airfoil trailing edge (6, 46) of the rotor blade (1), taking up a range of 15% to 30% of the length of the rotor blade (1).

5. The rotor blade (1) according to claim 1, wherein the at least one belt (9-9′″) has one or more casing layers (21, 21′, 31, 31′, 41, 41′), composed of fiber reinforced composite having fibers aligned unidirectionally in the direction of a longitudinal extension of the belt (9-9′″), which substantially completely cover or cover the top and/or bottom of the belt (9-9′″).

6. The rotor blade (1) according to claim 1, wherein the shell (10, 10′, 14) or a shell part of the rotor blade has a core (11) which has a recess (12), extending in the direction of the longitudinal extension of the rotor blade, in which the at least one belt (9-9′″) is disposed.

7. The rotor blade (1) according to claim 6, wherein the core (11) and the at least one belt (9-9′″) are connected to the at least one layer (13, 13′) of the fiber reinforced composite material having fibers aligned unidirectionally in the direction of the longitudinal extension of the rotor blade (1), which extends at least in sections from the airfoil leading edge (5, 45) to the airfoil trailing edge (6, 46) of the rotor blade (1).

8. The rotor blade (1) according to claim 6, wherein the core (11), having the least one belt (9-9′″) disposed in its recess (12), is embedded on both sides in the one-part or multi-part shell (10, 14).

9. The rotor blade (1) according to claim 1, wherein the at least one belt (9-9′″) is disposed at an inside of the one-part or multi-part shell (10, 10′, 14).

10. The rotor blade (1) according to claim 9, wherein the at least one belt (9-9′″) is connected to the at least one layer (13, 13″) of the fiber reinforced composite material having fibers aligned unidirectionally in the direction of the longitudinal extension of the rotor blade (1), which extends at least in sections from the airfoil leading edge (5, 45) to the airfoil trailing edge (6, 46) of the rotor blade (1).

11. A wind power plant having at least one rotor blade (1) according to claim 1.

12. A method for the production of a rotor blade (1) for a wind power plant that extends from a rotor blade root (2) substantially to a rotor blade tip (3), comprising the steps of:
producing a one-part or multi-part shell (10, 10′, 14), at least partially from a fiber reinforced composite material,
disposing at least one belt (9-9′″) in the rotor blade (1) substantially in the direction of a longitudinal extension of the rotor blade (1), and
producing the at least one belt (9-9′″) from layers composed of a fiber reinforced composite material having fibers aligned unidirectionally in the direction of a longitudinal extension of the belt (9-9′″) and being joined to the one-part or multi-part shell (10, 10′, 14),
wherein a thickness of the at least one belt (9-9′″) decreases toward the blade root (2) in a blade root side section, whose length is at least 3% of the entire length of the belt (9-9′″),
wherein the shell (10, 10′, 14) is provided with at least one layer (13, 13′) of a fiber reinforced composite material having fibers aligned unidirectionally in the direction of the longitudinal extension of the rotor blade (1), and
wherein the layer (13, 13′) extends at least in one section along the longitudinal extension of the rotor blade (1) from an airfoil leading edge (5, 45) to an airfoil trailing edge (6, 46) of the rotor blade (1).
